(19) United States
(12) Patent Application Publication
(10) Pub. No.: US 2009/0249841 A1
(43) Pub. Date: Oct. 8, 2009

(54) Mnemonic combination locking system

(76) Inventor: David Aaron Holmes, Sonoma, CA (US)

Correspondence Address: David Aaron Holmes, 17577 Johnson Ave., Sonoma, CA, 95476, US

(21) Appl. No.: 12/378,975

(22) Filed: Feb. 20, 2009

Related U.S. Application Data
(60) Provisional application No. 61/070,701, filed on Mar. 24, 2008.

(51) Int. Cl. E05B 37/22; E05B 37/08; E05B 37/10; E05B 37/02; E05B 9/00; E05B 17/00; B23P 19/00

(52) U.S. Cl. 70/22; 70/332; 70/293; 70/315; 70/443; 70/431; 29/804

(57) ABSTRACT

A combination locking system has a combination lock comprising a plurality of sets of thematic component pictorial indicia imprinted upon a set of tumblers that when sequentially realigned form a series of gestalt composite images recognizable to a human operator. Only one of the composite images is the correct combination that unlocks the lock. A second embodiment of the combination locking system has a combination lock comprising a plurality of morphosyntactically conformational, paradigmatic semantic word string indicia that together form a myriad of grammatical and meaningful phrases, only one of which is the correct combination.

### CROSS-REFERENCE TO RELATED APPLICATIONS

The present application claims the benefit of U.S. Provisional Patent Appl. No. 61/070,701, filed Mar. 24, 2008, entitled “Mnemonic Combination Locking System,” which is incorporated by reference herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

This invention relates to combination locks, specifically to multipurpose combination padlocks, such as are used for securing gym lockers, steamer trunks, and security gates, as well as dedicated, inbuilt combination locks, such as are used for securing suitcases, diaries, and lockboxes.

### BACKGROUND OF THE INVENTION

The earliest example of a combination lock with multiple dials was discovered in a Roman-era tomb at the Kerameikos necropolis in Athens, Greece. Through the intervening centuries countless labyrinthine mechanical improvements to the hidden inner mechanism have been invented in an attempt to foil succeeding generations of ever more sophisticated thieves. Yet in their outward appearance, the padlocks of today still bear an uncanny resemblance to this ancient prototype.

Very few patents in the prior art are concerned principally with a combination lock's indicia (discriminating marks) per se. Since ancient times these indicia have been assumed to be numbers—most commonly the digits from zero to nine—or a set of alphanumeric symbols. Occasionally, arcane shapes or colors take the place of numbers and letters; decorative typefaces may be used; neon paint may be applied so that the indicia are more visible in low light; embossed braille symbols may be utilized to assist the blind. Nevertheless, a lock's combination has always been understood to be no more nor less than a secret code, and secret codes are invariably made up of sequences of discrete symbols.

Prior art combination locks are at best a necessary nuisance for their operators. Memorizing a preset combination can be exceedingly taxing on the mind. Permutation locks offer a minor advancement in giving the lock's operator the responsibility of setting his own combination. One soon exhausts one's personal databank of familiar numbers, such as relatives' birthdates, former and current street addresses, and anniversaries; and one is prone eventually to forget which among these possibilities was finally chosen to be the combination. This practice also leaves the operator with the anxious feeling that someone else might just as easily crack the code. Conversely, using a wildly random combination offers no substantial mnemonic hook to sustain the memory, and in time the combination will be forgotten. There is nothing about the operator's encounter with a prior art alphanumeric combination lock that can be counted on to trigger the memory of the correct combination.

In designing prior art combination locks, common sense dictates that the number of indicia on each tumbler should be as large as possible to maximize the total number of combinations. The individual symbols, therefore, need only be large enough to be legible. What results is a combination viewing zone that takes the form of a very short and very wide rectangle, perhaps 0.25″×1.5″—excellent proportions for a single line of type but certainly not a typical or practicable canvas size for graphic artwork. For this and other reasons, the present invention has eluded many generations of lock makers.

Recently issued U.S. Pat. No. 7,376,899 B2 to Mantyla (2008) discloses a computer application that employs a graphical password described in the patent's abstract as being “composed by selecting partial images from different subgroups and by combining the selected partial images into one complete identifier image.” This can be understood to represent a natural progression in the evolution of security systems for computers, whose graphic-arts-compatible screens have facilitated countless such innovations. The present invention, however, requires a non-obvious leap of imagination: to envision the commonplace, utilitarian combination padlock as having the potential to be a creative medium for the display of full-color composite artwork and to recognize the mnemonic advantages this would provide.

### BRIEF SUMMARY OF THE INVENTION

It is an object of the present invention to provide a newly configured combination lock that can display a wide variety of thematic composite images from multiple component pictorial or semantic word string indicia and to provide a method for producing the necessary thematic paradigm of component pictorial or component semantic word string indicia.

In order to fully convey the improvement over prior art combination locks represented by the combination locking system of the present invention, a brief discussion of pertinent findings in the empirical sciences of human memory (mnemonics) and linguistic meaning (semantics) is essential. A key-operated lock depends for its effectiveness upon the resilience and shape memory of the metal alloy of which it is made. A shoddily manufactured pot metal key cannot be depended upon to align the lock's pins properly at the sheer line. A combination lock depends in like manner upon the mnemonic resilience of the mental imagery that recalls to the operator's mind the correct combination.

One of the most easily corruptible memories is a series of random digits, making operators of the most common commercially available padlocks more prone to forgetting their combination. Alphanumeric permutation padlocks are a slight improvement in this regard, but the number of different combinations that can be effectively memorized and differentiated without extensive mnemonic training is seriously limited.

Memories are stored within the brain's neuronal network and are routinely accessed by employing natural and artificial mnemonic devices, prompts, triggers, and keys. Having deeply embedded, multisensory connections and multiple semantic referents greatly facilitates the recollection of memories. Particular areas of the brain are dedicated to processing and recalling specific categories of memories. One brain areas specializes in the recollection of familiar faces, and damage to this area of the brain results in a condition known as prosopagnosia or “face blindness.” The combination lock of the present invention takes advantage of the brain's own neurological mnemonic systems by employing gestalt composite pictorial imagery with familiar component parts juxtaposed in novel, striking, and therefore memorable combinations.

Similarly, the morphosyntactically conformational, paradigmatic word string indicia of the linguistic embodiments of the present invention draw upon the operator's innate linguistic knowledge base and his ability to formulate a single, cohesive, higher-order semantic meaning evoking rich mental imagery from these linguistic components. What the operator trains his mind to produce in the presence of this newly configured combination lock is either the mental or visual imagery or the semantic construct, which is the meaning itself. From either of these recollections, he is then able, by manipulating the tumblers, to reconstruct the original semantic object from the component word string indicia that are present to his view and effortlessly unlock the lock.

Much more so than in any prior art embodiments, a combination lock of the present invention also functions as a mnemonic device in and of itself. The very form of the lock, by virtue of its extraordinary appearance, aids in the recollection of its own combination, but only for someone who has spent time in the presence of that embodiment of the lock while engaged in the process of memorizing the combination—in other words, the operator himself. The lock is manufactured so as to display one particular, self-evident, and never before encountered theme, whether it is, for example, a composite face formed from the partial faces of film stars, a composite animal body, a street scene, a decorated Christmas tree, a Rube Goldberg-style mechanical invention, a still life, or a particular linguistic structure such as a haiku poem or maxim. The images that are visible upon the tumblers of the combination lock itself automatically prompt the operator's mind to move along the familiar mental/neurological pathway toward the memory of the correct combination.

For a modern day lock operator burdened with having to memorize his Social Security number, his bank account numbers, many street addresses, zip codes, and telephone numbers, birthdays, and the like, the random alphanumeric indicia of a jumbled prior art combination lock cannot produce any significant mnemonic effect. Numbers and letters are simply numbers and letters, individually devoid of higher order semantic meaning. An operator of a prior art combination lock must carry with him in his mind whatever mnemonic device he can cobble together that helps him recall the combination or else write it down in a secret place, thus compromising his security. The sight of the prior art combination lock itself will not remind him of the combination that unlocks it. On the other hand, any human operator of average mnemonic aptitude—even, or perhaps particularly, a young child—could easily remember a dozen combinations to a dozen different combination locks in accordance with the present invention, if they were all artfully designed and sufficiently thematically dissimilar from one another.

One embodiment of the present invention shows a variety of composite animals, known as chimaeras. Chimaeras are archetypal creatures that appear in many human mythological systems, evidencing the innate, panhuman brain structures and mental systems specifically adapted for animal recognition and sorting. As intermediate animals themselves in the prehistoric food chain, being predator to some and prey to others, humans were prompted to evolve a superior capacity for making fine distinctions in their observations of animal. This is patently revealed in the masterful Paleolithic cave paintings of Lascaux. In Greek mythology, Chimaera was a fabulous, fire-breathing she-monster with the head of a lion, the body of a goat, and a serpent's tail. The fact that countless such specific formulations of chimaeras have survived in the oral traditions of the world from antiquity to the present day gives strong evidence for the mnemonic power of a bizarre composite image to secure itself in memory.

The accompanying drawings show a newly configured combination lock in which the viewable surface area has been expanded and the proportions adjusted to more closely match those of a traditional painter's canvas. In some cases this has been accomplished by decreasing the number of indicia per tumbler from the customary ten digits to eight or seven or even fewer. In other instances the diameters and widths of the tumblers have been increased, though still remaining within the limits of practicality. The images, which are printed in full color at 600 to 1200 dpi on imprintable paper or plastic medium, are affixed to the tumblers and covered with a protective, transparent plastic sheath. This allows photographic quality artwork to be faithfully reproduced, such that the individual pixels that make up the images are indistinguishable to the naked eye.

### BRIEF DESCRIPTION OF THE SEVERAL VIEWS OF THE DRAWING

The novel features believed to be characteristic of the present invention are set forth with particularity in the appended claims. The invention itself may best be understood by reference to the following description taken in connection with the accompanying drawings in which:

FIG. 1 is a perspective view of a preferred embodiment of the combination lock in accordance with the present invention, showing a combination padlock with component pictorial indicia displaying a fanciful composite animal theme;

FIG. 2 is a perspective view of a second preferred embodiment of the combination lock in accordance with the present invention, showing composite pictorial and paradigmatic word string indicia displaying a horizontally split face and a human referent, attributive adjective-noun theme;

FIG. 3 is a perspective view of the combination lock of FIG. 1 in an unlocked position with the end portion of the lock body rotated 90° clockwise, showing one method of changing the combination on a permutation lock;

FIG. 4 is an exploded perspective view of a third preferred embodiment of the combination lock in an unlocked position with the end portion of the lock body and one of the tumblers removed, showing a second method of changing the combination on a permutation lock;

FIG. 5 is a perspective view of a fourth preferred embodiment of the combination lock, showing how a composite theme with four pictorial components can be displayed on a lock with only three tumblers and no fiducial mark;

FIG. 6 is a perspective view of a padlock with prior art numerical indicia that is not in accordance with the present invention. It is shown for comparison and contrast with the combination lock of FIG. 5;

FIG. 7 is a perspective view of a fifth preferred embodiment of the combination lock, showing how the lock of FIG. 2 can be manufactured in such a way as to require only three dials and no fiducial mark;

FIG. 8 is a perspective view of a sixth preferred embodiment of the combination lock with a morphosyntactically conformational, paradigmatic, semantic word string theme;

FIG. 9 is a perspective view of a seventh preferred embodiment of the combination lock with embossed indicia;

FIG. 10 is a perspective view of a three-dimensional, embossed, relief component pictorial indicium;

FIG. 11 is a table showing a paradigm of pictorial indicia;

FIG. 12 is a table showing a paradigm of morphosyntactically conformational, semantic word strings;

FIG. 13 is a table showing a second word string paradigm;

FIG. 14 is a table showing a complex word string paradigm in the highly inflective German language;

FIG. 15 is a table showing English translations of several of the possible German sentences generated by the paradigm shown in FIG. 14;

FIG. 16 is a table demonstrating how sixteen distinct German verbs can be formed from combinations of the four verb-stem indicia and four separable-prefix indicia shown in FIG. 14;

FIGS. 17A through 17J are a series of graphic illustrations showing the principal steps in a method for generating paradigmatic component pictorial indicia for a preferred embodiment of the combination lock with a composite pictorial theme;

FIG. 18 is an abridged table showing a paradigm of indicia comprising a theme with both composite pictorial and word elements;

FIG. 19 is an abridged table showing a paradigm of indicia wherein each indicium has both composite pictorial and morphosyntactically conformational, semantic word string elements;

FIG. 20 is an abridged table showing a paradigm of indicia comprising a morphosyntactically conformational, semantic word string theme with a pictorial element;

FIG. 21 is a perspective view of a preferred embodiment of the combination lock in accordance with the present invention, showing a dedicated, inbuilt lock for a diary with component pictorial and paradigmatic semantic word string indicia; and

FIG. 22 is an exploded perspective view of a disc-type tumbler, showing a folded rectangular strip of imprintable paper or plastic medium and a protective, transparent plastic sheath.

### REFERENCE NUMERALS IN THE DRAWINGS

30 combination lock
32 lock body
34 shackle
36 aperture
38 reset position indicator
40 tumbler
42 viewable surface area
44 indicia
46 primary axis
48 rectangular surfaces
50 lateral edges
52 primary combination viewing area
54 rectangular projections
56 arrows
58 mutually proximal edges
60 indicia viewing zones
62 chimaera
64 thematic, paradigmatic, component pictorial indicia
66 concentric, nested circular dials
68 substantially coplanar faces
70 concentric, nested, textured control knobs
72 fist
74 reset button
76 horizontally split face
78 human referent, attributive adjective-noun word string
80 morphosyntactically conformational, paradigmatic semantic word string indicia
82 rotatable end portion
84 removable end portion
86 hidden locking mechanism
88 gear teeth
90 cogs
92 prior art numerical indicia
94 fiducial set of component indicia
96 embossed, relief component word string indicia
98 three-dimensional, embossed, relief component pictorial indicium
100 overall, generic composite theme
102 guidelines
104 sections
106 rectangles
108 graphic layout template
110 warped section
112 lower half of a face
114 beret
116 bow tie
118 single word indicium
120 morphosyntactically conformational, paradigmatic semantic word string theme
122 single pictorial element
124 diary
126 front cover
128 flanges
130 rivets
132 hook
134 back cover
136 axis of rotation
138 steel hub
140 hard plastic tumbler body
142 partially folded rectangular strip
144 imprintable paper or plastic medium
146 multiple indicia images
148 protective, transparent plastic sheath

### SUMMARY

In accordance with the present invention, there is provided a mnemonic combination locking system with thematic, paradigmatic component indicia.

### DETAILED DESCRIPTION OF THE INVENTION

The present invention will now be described more fully hereinafter with reference to the accompanying drawings, in which several preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art. Like numbers refer to like elements throughout the figures. Prime to sextuple prime notations refer to alternate embodiments of like elements.

The present application claims the benefit of U.S. Provisional Patent Appl. No. 61/070,701, filed Mar. 24, 2008, entitled “Mnemonic Combination Locking System,” which is incorporated by reference herein in its entirety.

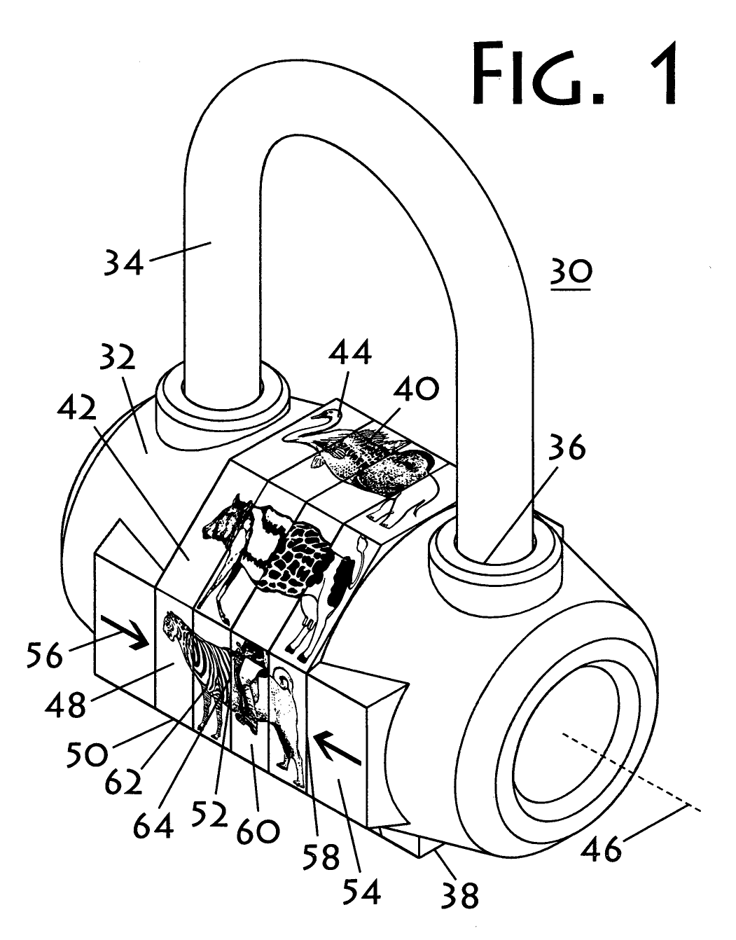

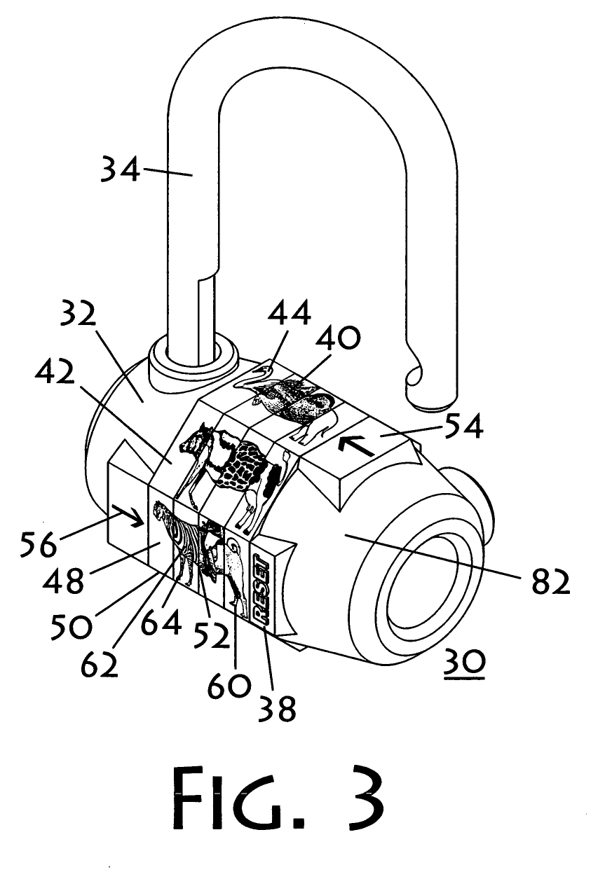

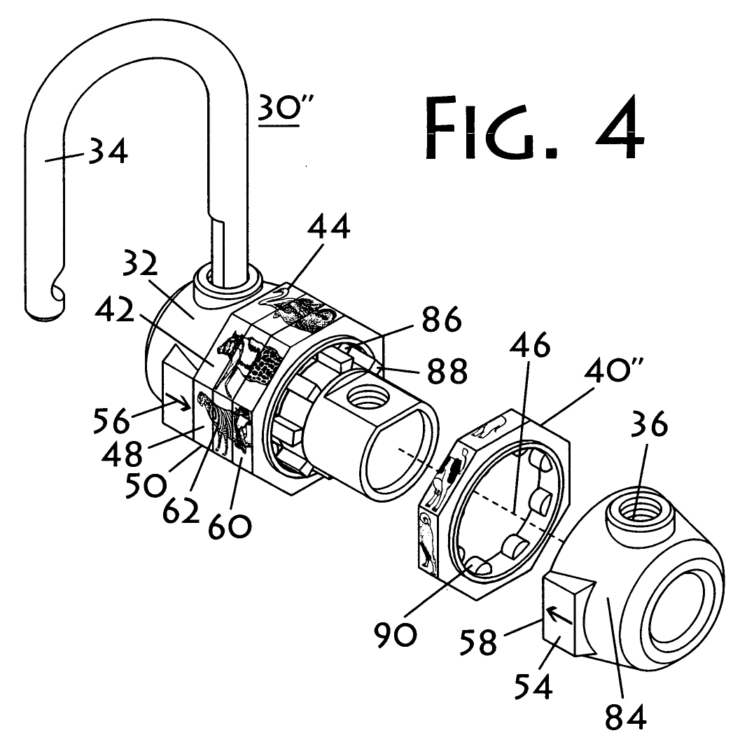

FIG. 1 is a perspective view of a preferred embodiment of the combination lock 30 in accordance with the present invention. The figure shows a type of resettable combination lock known as a permutation lock. A great many variations in the mechanical structure of this type of lock are well documented in the prior art. The figure shows a lock body 32, a shackle 34, an aperture 36 from which the shackle 34 must be removed before the combination can be reset (FIGS. 3 and 4), a reset position indicator 38, which can be better visualized in FIG. 4, a set of four disc-type tumblers 40, viewable surface area 42, and indicia 44 imprinted upon the viewable surface area. In this embodiment of the invention, the tumblers 40 are in the general form of octagonal prisms, coaxially nested with their respective octagonal faces substantially mutually abutting, with all four tumblers aligned along a common primary axis 46, and being rotatable about the primary axis. The figure shows rectangular surfaces 48 of the tumblers allowing for the display of eight indicia upon each tumbler. The smaller number of indicia in this embodiment reduces the number of permutations from 10×10×10×10=10,000 to 8×8×8×8=4096 possible combinations. This disadvantage is offset, however, by other practical and aesthetic advantages. The rectangular surfaces 48 of the octagonal prisms provide a contiguous, smooth, flat, clear-cut, and substantially larger surface area for creating and viewing the artwork formed by the combined indicia 44. In this configuration, the tumblers 40 can easily be designed so that the complete composite image forms an aesthetically pleasing golden rectangle, whose side lengths are in the golden ratio of 1:φ (one-to-phi, or approximately 1:1.618), which represents the most conventional canvas proportions for portrait and landscape paintings. The figure shows lateral edges 50 of the tumblers 40 that obviate the need for textured, grippable surfaces found in prior art cylindrical tumblers. The octagonal form itself allows for easy gripping and turning of the tumblers 40.

Still referring to FIG. 1, the figure shows a primary combination viewing area 52, two rectangular projections 54 and two arrows 56. The primary combination viewing area is the rectangular area formed in the space between the two rectangular projections 54 of the lock body 32 that are marked with the two arrows 56. The rectangular projections and the arrows together function as fiducial marks. Two mutually proximal edges 58 of the rectangles of the raised, rectangular projections 54 align with the rectangular surfaces 48 of the tumblers 40 when they are properly positioned. The primary combination viewing area 52 comprises four indicia viewing zones 60, one for each of the tumblers. When any of the 4096 possible combinations of the indicia 44 are properly aligned in the four indicia viewing zones 60, a single composite image of a unique, fanciful composite animal or chimaera 62 appears in the primary combination viewing area. The primary combination viewing area 52 displays the four thematic, paradigmatic, component pictorial indicia 64 (the tiger's head, the zebra's forelimbs, the horse's midsection, and the pug's hindquarters) that form the composite image that is the correct combination for unlocking the combination lock.

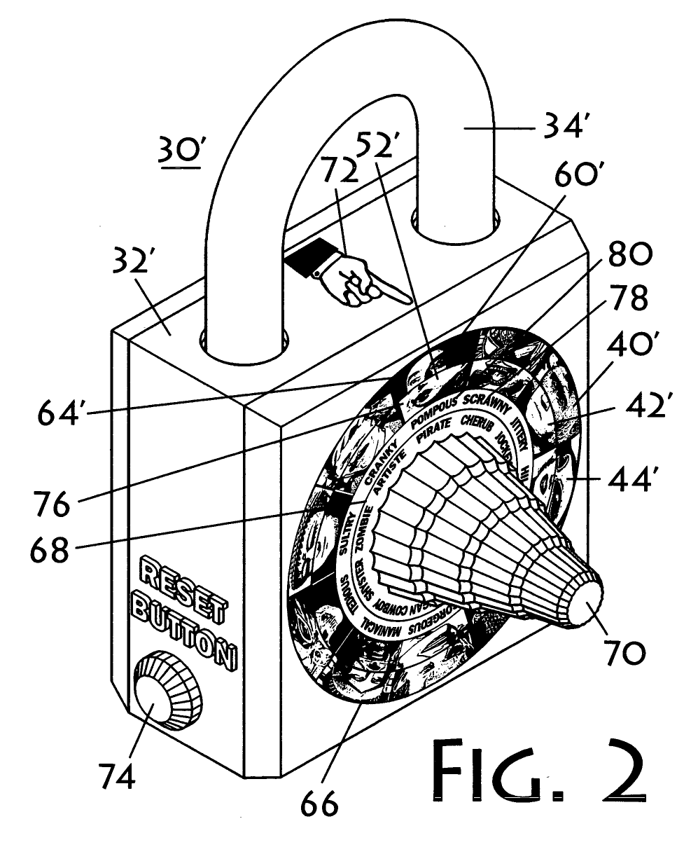

FIG. 2 is a perspective view of a second preferred embodiment of the combination lock 30′ in accordance with the present invention in the form of a permutation lock. The figure shows the lock body 32′ and the shackle 34′. The figure shows the tumblers 40′, which in this embodiment are in the form of concentric, nested circular dials 66 of graduated circumference, and also shows a set of concentric, nested, textured control knobs 70 by means of which the positions of the dial-type tumblers 40′ are adjusted. The figure also shows substantially coplanar faces 68 of the concentric, nested, circular dials. This second embodiment of the invention has twelve indicia 44′ upon each of the tumblers 40′, permitting 12×12×12×12=20,736 possible combinations.

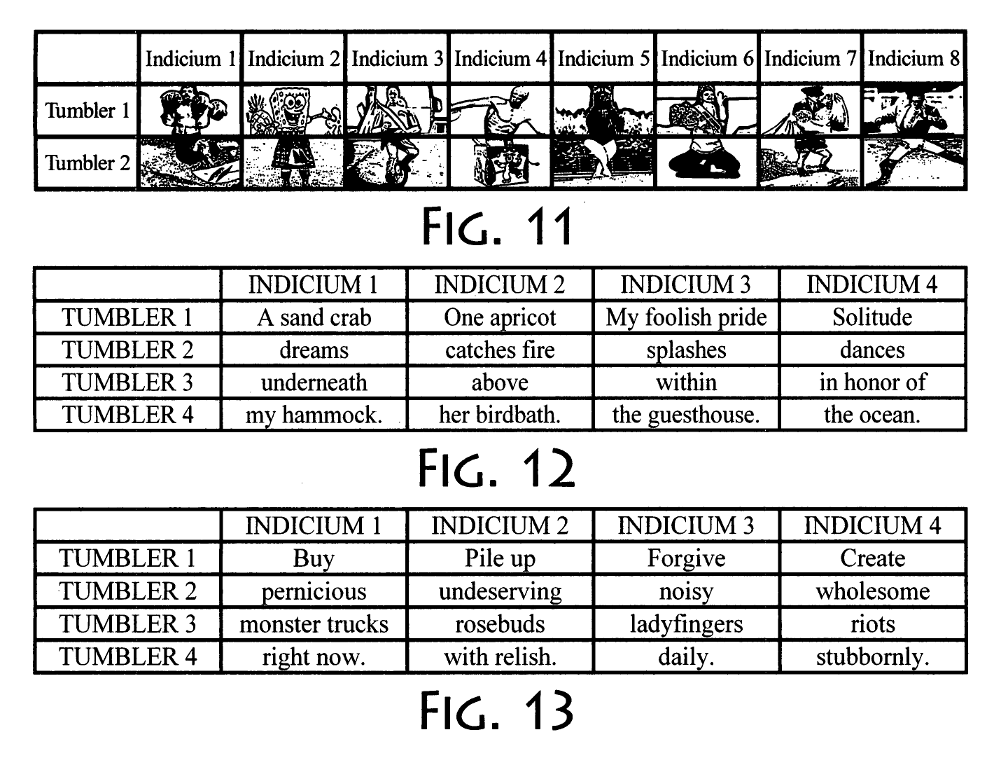

A lock of this type can also employ a resettable combination (or permutation) mechanism that is operable only from the unlocked position, and many such lock designs appear in the prior art. Locks with multiple dials are unconventional. Far more popular are those with a single dial and one set of numerical indicia, wherein the lock is unlocked by sequential movements of the dial, alternating clockwise and counterclockwise, aligning a series of numbers with a fiducial mark. The lock of FIG. 2 with multiple dial-type tumblers 40′ is an ideal vehicle for a thematic composite pictorial (FIG. 11) or morphosyntactically conformational, paradigmatic, semantic word string theme (FIGS. 12, 13, and 14), however. A clear advantage of this design is that all indicia 44′ are simultaneously viewable from the frontal aspect.

Still referring to FIG. 2, the figure shows the wedge-shaped primary combination viewing area 52′, which comprises the combined topmost twelfth parts of the viewable surface area 42′ of the tumblers 40′ and a symbolic pointer finger printed upon the lock body, which is a fiducial mark referred to as a hand or fist 72. The figure also shows a reset button 74 that when pressed by the operator engages a combination resetting mechanism and allows the operator to change the combination. Neither a hidden locking mechanism nor a combination resetting mechanism is shown in this figure, as their specific configurations have no bearing upon the present invention.

Still referring to FIG. 2, the primary combination viewing area 52′ is divided into four wedge-shaped indicia viewing zones 60′, the two outermost indicia viewing zones displaying a horizontally split face 76 formed by two thematic, paradigmatic, component pictorial indicia 64′ and the two innermost indicia viewing zones displaying a human referent, attributive adjective-noun word string 78 formed by two morphosyntactically conformational, paradigmatic semantic word string indicia 80. Taken together, the images and words form the easily recognizable theme of a bizarre and memorable face with its curious, incongruous verbal description.

FIG. 3 is a perspective view of the combination lock 30 of FIG. 1. It shows a rotatable end portion 82 of the lock body 32 rotated 90° clockwise, illustrating one method of changing the combination on a permutation lock. FIG. 3 shows the reset position indicator 38 that is visibly aligned with the primary combination viewing area 52. The figure shows the shackle 34 released from the lock body 32. The combination can only be changed when the lock is in an unlocked position and the shorter end of the shackle 34 has been removed from the aperture 36 (FIGS. 1 and 4), not visible in this view, in the rotatable end portion 82 of the lock body 32, allowing the rotatable end portion to freely rotate. This ensures that only the owner of the lock (or someone knowledgeable of the initial combination) can readily alter the combination. This type of permutation lock (with prior art indicia) is at present commercially available.

FIG. 4 is an exploded perspective view of a preferred embodiment of the combination lock 30″ otherwise identical to that of FIG. 1 (with an alternative permutation mechanism to that of FIG. 3) and shows a removable end portion 84 of the lock body 32 and one of the disc-type tumblers 40″ removed, illustrating a second method of changing the combination on a permutation lock. The figure shows the shackle 34 released from the lock body 32, a hidden locking mechanism 86, and a combination resetting mechanism comprising eight gear teeth 88 that mesh in eight distinct configurations with eight corresponding cogs 90 on the inner surface of the tumblers. The combination resetting mechanism is not further described because it is well known in the prior art and pertains only peripherally to the present invention. Permutation padlocks of this type (also with prior art indicia) are likewise currently commercially available. Several additional replacement tumblers with additional configurations of alphanumeric indicia for forming three or four letter words, initials, or letter-number combinations are included with the purchase of the prior art padlock. The combination can only be changed or replacement tumblers installed when the lock is in an unlocked position and the shorter end of the shackle 34 has been removed from the aperture 36 of the end portion of the lock body, allowing the removable end portion 84 and the tumblers 40″ to be removed, reset and replaced. One must be knowledgeable of the initial combination to open the lock in order to change the combination.

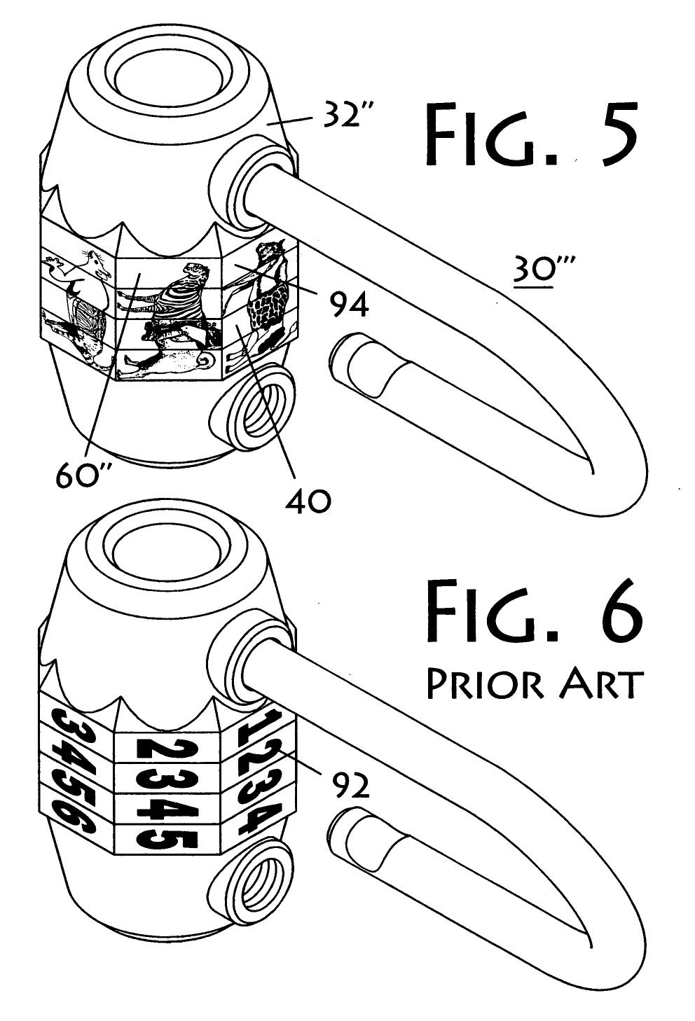

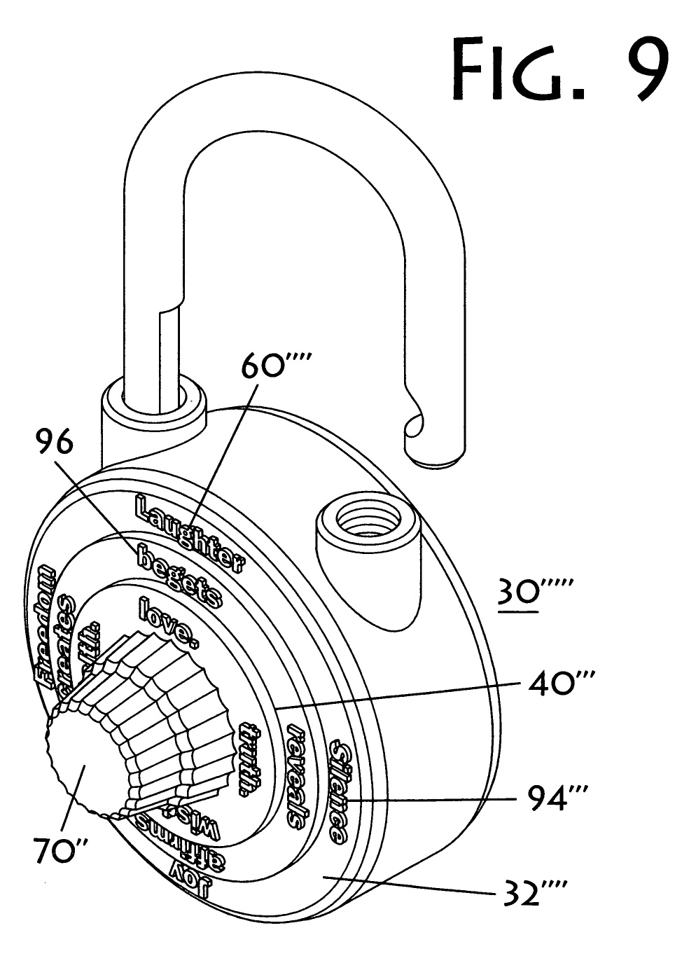

FIGS. 5, 7, and 8 are perspective views of preferred embodiments of the combination lock 30′″, 30″″ in accordance with the present invention, each showing a novel feature described below. FIG. 9 shows an embodiment of the combination lock 30′″″ in accordance with the present invention that also shows the novel feature.

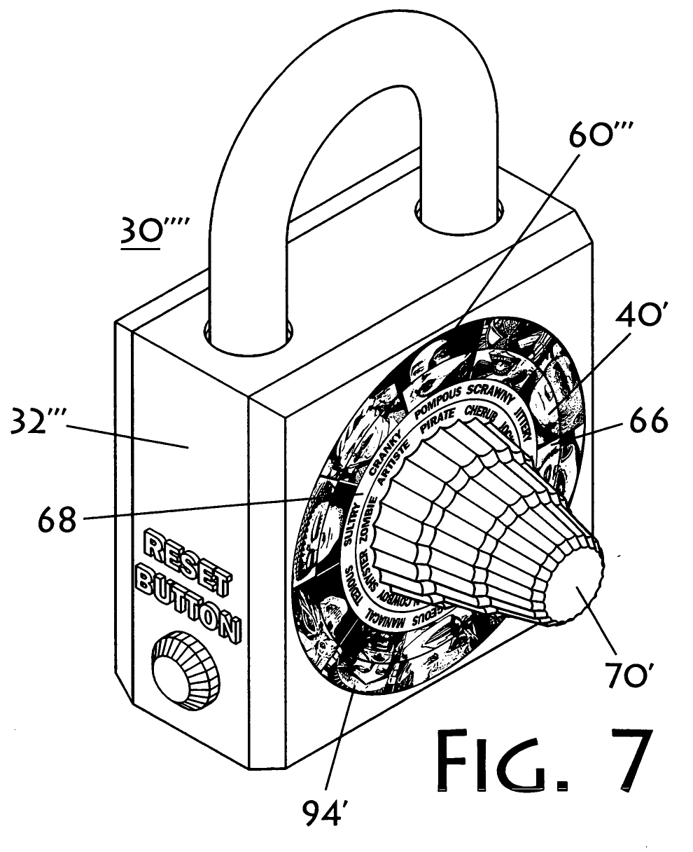

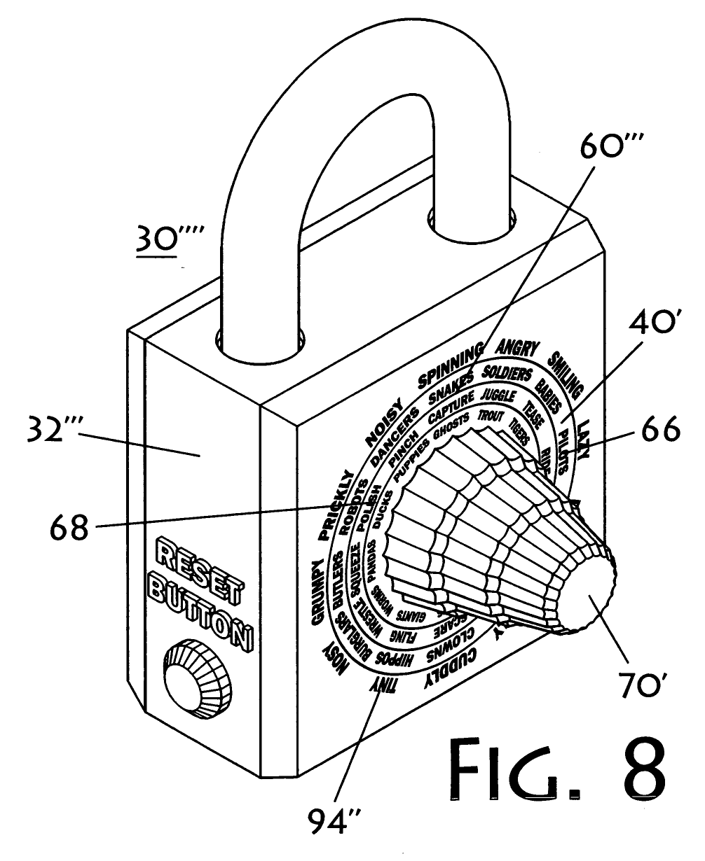

FIG. 6 shows a prior art padlock that is not in accordance with the present invention. It is shown for comparison and contrast with the combination lock of FIG. 5. FIGS. 5, 7, 8, and 9 show embodiments of the combination lock 30′″, 30″″, 30′″″ that to all appearances have no fiducial mark of any kind. Instead, the figure shows a fiducial set of component indicia 94, 94′, 94″, 94′″ that is printed or embossed on the lock body 32″, 32′″, 32″″ itself. This configuration provides the double advantages of disguising the location of the primary combination viewing area from a would-be thief and increasing the surface area for the display of artwork. FIG. 5 shows four discrete indicia viewing zones 60 and only three movable disc-type tumblers 40. FIGS. 7 and 8 show four discrete indicia viewing zones 60′ and only three movable dial-type tumblers 40′ in the form of nested, concentric circular dials 66 with substantially coplanar faces 68 and three concentric, nested, textured control knobs 70′. FIG. 9 shows two movable dial-type tumblers 40′″, two concentric, nested, textured control knobs 70″, and three indicia viewing zones 60″″.

Referring to FIG. 6, the figure shows prior art numerical indicia 92 on a lock that is mechanically identical to the lock of FIG. 5. FIG. 6 shows that whereas the novel feature provides the advantages cited above to the composite pictorial lock of FIG. 5, this is not the case with the lock of FIG. 6. Having a combination with an even longer string of easily forgotten numerals to memorize would in the lock of FIG. 6 constitute a distinct disadvantage.

Referring to FIG. 9, the figure is a perspective view of a preferred embodiment of the combination lock 30′″″ that shows embossed, relief component word string indicia 96 stamped or molded onto the dial-type tumblers' 40′″ surfaces. The figure demonstrates another means for producing legible word indicia.

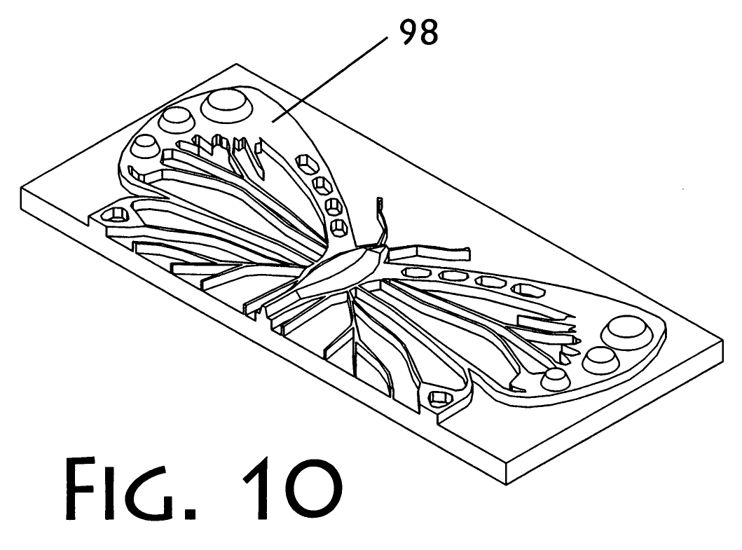

FIG. 10 shows a three-dimensional, embossed, relief component pictorial indicium 98, represented schematically for clarity in the figure by a three-dimensional, relief image of the forward half of a butterfly. This demonstrates how the combination lock of FIG. 9 could be manufactured with an embossed, relief composite pictorial theme.

FIGS. 11 to 16 and FIGS. 18 to 20 show tables demonstrating the concept of a paradigm employed in the design and manufacture of any specific embodiment of the combination lock in accordance with the present invention. FIG. 11 shows, for simplicity, a table depicting a basic two-part pictorial paradigm. The two rows of images represent two of the tumblers of an embodiment of the combination lock. The combination lock may be of the form of the lock of FIG. 1 or FIG. 2, for example. The images that appear in the last eight columns of each of these two rows represent the eight pictorial exemplar indicia for each of the two tumblers.

Referring to the table of FIG. 1, tumbler 1, indicium 1 shows an image that represents a black-and-white photographic image of the top half of the body of a weightlifter with barbells. Indicium 2 shows an image that represents a color image of the top half of a cartoon character's body. Indicium 3 shows an image that represents a color photographic image of the top half of a crash test dummy's body. Indicium 4 shows an image of the top half of a Roman sculpture of a discus thrower. Indicium 5 shows an image of the top half of a bear's body. Indicium 6 shows an image of the top half of the body of a woman winning a Miss Universe contest. Indicium 7 shows an image of the top half of a porcelain figurine depicting a policeman-groom carrying his bride. Indicium 8 shows an image of the top half of a businessman running hurdles while holding a telephone and briefcase.

Still referring to the table of FIG. 11, tumbler 2, indicium 1 shows an image of the bottom half of the body of a surfer. Indicium 2 shows an image of the bottom half of a Scotsman in a kilt. Indicium 3 shows a photographic image of the bottom half of a man on a unicycle. Indicium 4 shows an image representing a color photographic image of the bottom half of a jack-in-the-box. Indicium 5 shows an image of the bottom half of a female gymnast on a balance beam. Indicium 6 shows an image of the bottom half of a woman practicing yoga. Indicium 7 shows an image of the bottom half of a backpacker standing upon the lip of the Grand Canyon. Indicium 8 shows an image of the splayed legs of a skydiver.

Still referring to the table of FIG. 11, the generic composite pictorial theme represented by the 8×8=64 possible composite images is a hybrid whole body formed from incongruous combinations of the top and bottom halves of the bodies portrayed by the indicia. Most but not all of the specific and distinct pictorial exemplar indicia are human. One is a bear. Another is a cartoon sea sponge. A third is a crash test dummy. Yet the theme would be immediately recognizable to a human operator, even if he was a very young child, and each of the exemplar indicia would be recognizable as component parts of a conceptual whole. If, for example, any of the images from tumbler 1 were to be placed on tumbler 2, or vice versa, the error would be immediately apparent to the operator. The two tumblers function as a pictorial template for a plurality of composite images made from the 64 possible configurations of the two sets of subthematic, paradigmatic pictorial exemplar indicia.

FIGS. 12, 13, and 14 show tables giving examples of non-pictorial, linguistic paradigms used in the design and manufacture of a combination lock in accordance with the present invention. From a linguistic perspective, each of these three tables shows a different morphosyntactically conformational, paradigmatic semantic word string theme, abridged for clarity of presentation.

In FIG. 12, the first row of indicia (for tumbler 1) shows a variety of noun phrases, either as single nouns (“solitude”), or in combination with determiners such as numerals (“one”), demonstratives (“that”), possessives (“my”), and modifiers such as attributive adjectives (“ancient”), and attributive nouns (“sand”). The second row of indicia (for tumbler 2) shows present tense verbs (“dances”) or verb phrases (“catches fire”). The third row of indicia (for tumbler 3) shows prepositions, and the fourth row of indicia (for tumbler 4) shows objects of those prepositions.

FIG. 13 shows a different linguistic paradigm resulting in a different linguistic theme for another preferred embodiment of the combination lock. It begins with a verb in command form (“Buy”), which is followed by an attributive adjective (“pernicious”), a direct object noun phrase (“monster trucks”), and an adverb (“stubbornly”) or prepositional phrase (“with relish”).

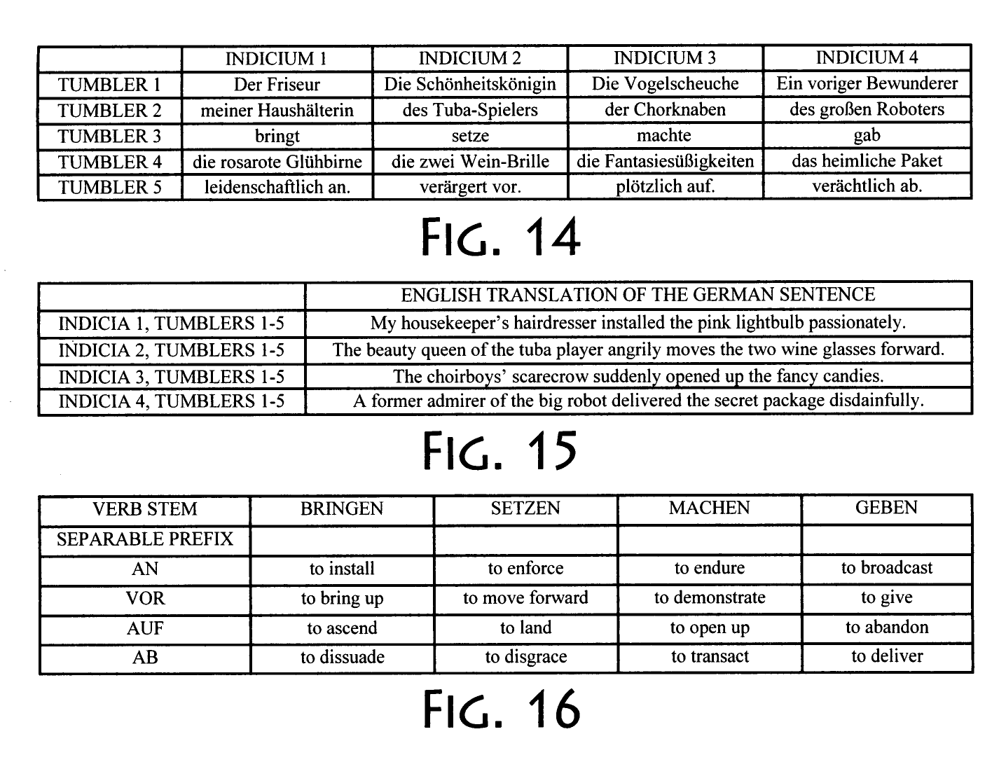

FIG. 14 shows a linguistic paradigm for a combination lock in the German language. German is a canonical example of a fusional or inflective language, which means that a single lexeme's (basic word form's) morphology (appearance and phoneme structure) changes according to its syntactic role in the sentence. German is rife with paradigms of all kinds: for the declension of definite and indefinite articles, pronouns, nouns and attributive adjectives in the nominative, accusative, genitive and dative cases; and for the conjugation of verbs in all tenses and moods, including separable- and inseparable-prefix verbs. The intricate morphosyntactic structure of German makes it an ideal language for use in an embodiment of the combination lock of the present invention.

FIG. 15 shows translations into English of the German sentences generated by the tumblers of FIG. 14 when the first, second, third, and fourth sets of indicia are aligned.

FIG. 16 shows the translations into English of the distinct German verbs generated by the combinations of the separable prefixes and the verb stems used in FIG. 14.

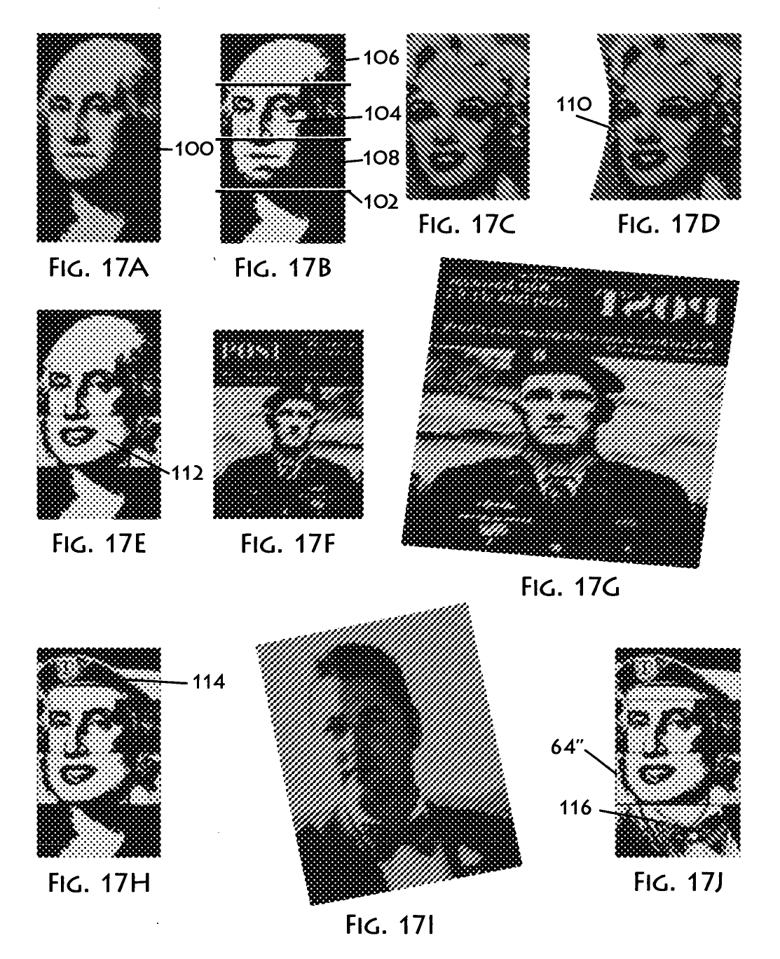

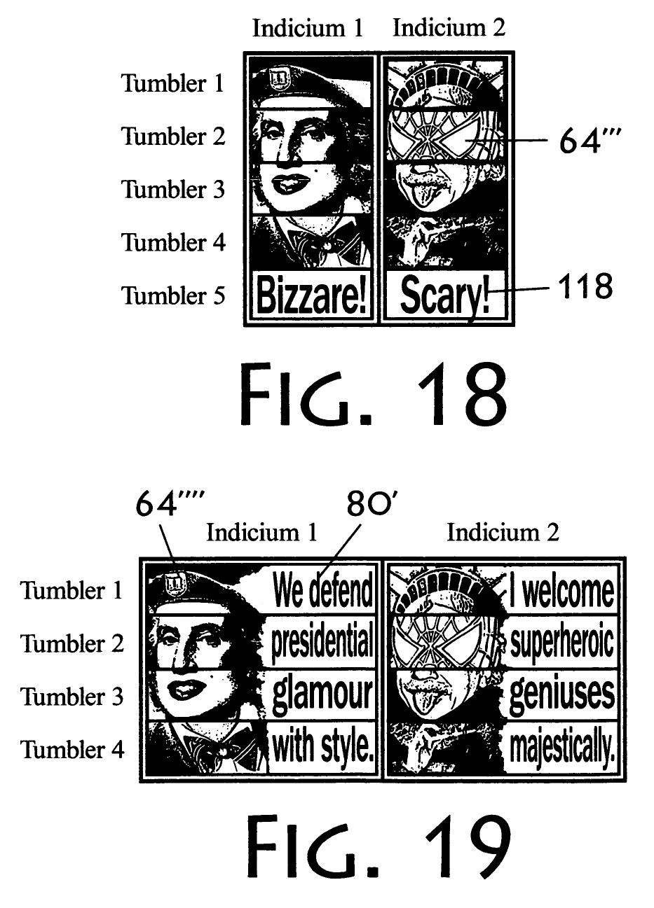

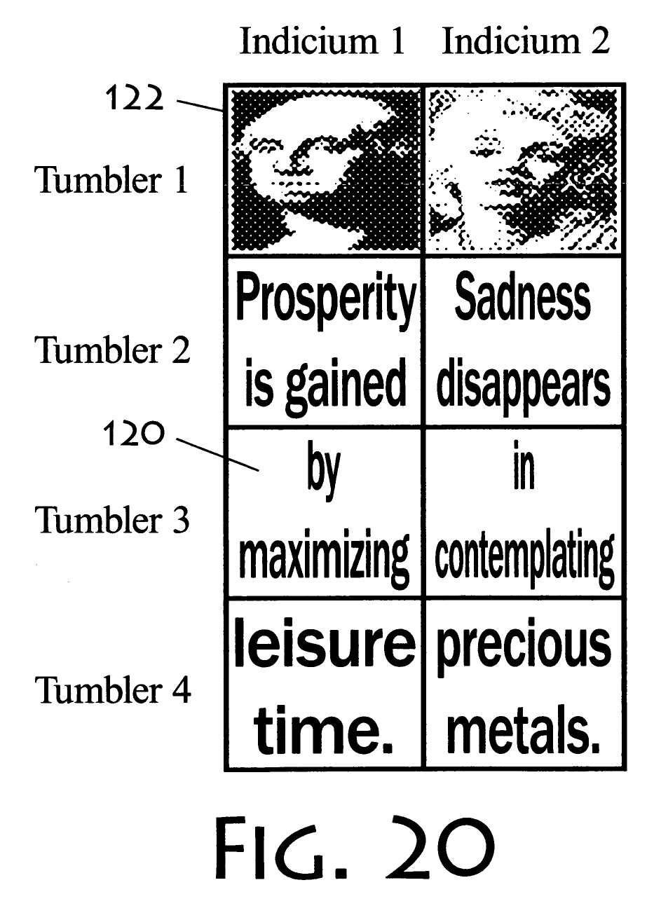

FIGS. 17A to 17J show a series of graphic illustrations of the principal steps in a method for generating thematic, paradigmatic, component pictorial indicia 64″ (FIG. 17J) for a preferred embodiment of the combination lock with a composite pictorial theme. All of the steps in this process can be completed using a computer system with available computer graphic arts and photographic image processing software.

FIG. 17A shows an overall, generic composite theme 100 derived from an original or found graphic artwork. The theme 100 in this case is a three-quarter profile human face, turned slightly toward the viewer's left.

FIG. 17B shows a graphic layout template derived from the generic composite theme that will be used to align the component images into a composite image. The template shows the three-quarter profile human face divided horizontally by guidelines 102 into four sections 104: above the mid-brow, from mid-brow to the tip of the nose, from the tip of the nose to just under the chin, and from just under the chin to the bottom of the neck. Four rectangles 106 that result from this division establish a graphic layout template 108 for the thematic, paradigmatic, component pictorial indicia 64″. Only the second of the four sections 104 from the artwork is used as an exemplar indicium; the rest of the artwork will be cropped and discarded. The composite picture that represents the combination is not a puzzle to be solved by aligning matching component images correctly. None of the exemplars from any of the subsets of indicia are intended to match any other exemplars. They should all be equally incongruous in any combination.

FIG. 17C shows a second found graphic artwork, which the designer will attempt to conform to the graphic layout template 108 (FIG. 17B) using the warp transformation of the photographic image processing software.

FIG. 17D shows a warped section 110 on the left side of the second found graphic artwork of FIG. 17C as a result of the transformation procedure.

FIG. 17E shows the image of FIG. 17D after it has been cropped and shows a lower half of a face 136, which will be used as a second exemplar indicium.

FIG. 17F shows a found image from which the designer plans to extract a section of the image as an exemplar indicium for the first tumbler.

FIG. 17G shows the image of FIG. 17F after three image processing transformations have been applied to it. It has been reversed horizontally, stretched horizontally, and rotated clockwise.

FIG. 17H shows a beret 114 of the image of FIG. 17G, cropped for use as a third exemplar indicium.

FIG. 17I shows a third found image that has been adjusted for size, narrowed, and rotated counterclockwise.

FIG. 17J shows a bow tie 116 of the image of FIG. 17I, cropped for use as a fourth exemplar indicium and the thematic paradigmatic, component pictorial indicia created by this method. FIG. 17J also shows the first complete composite image made through this graphic design process. This composite image is one possible combination for this embodiment of the combination lock.

FIG. 18 is a table showing an abridged paradigm for a preferred embodiment of the combination lock in accordance with the present invention with thematic, paradigmatic, component pictorial indicia 64′″. The fifth tumbler displays a single word indicium 118. In this embodiment the word indicium 118 is an interjection that expresses an emotional reaction to the composite image formed by the thematic, paradigmatic, component pictorial indicia 64′″.

FIG. 19 is a table showing an abridged paradigm for a preferred embodiment of the combination lock in accordance with the present invention, showing thematic, paradigmatic, component pictorial indicia 64″″ and thematically related, morphosyntactically conformational, paradigmatic component word string indicia 80′, wherein each exemplar of the thematic, paradigmatic, component pictorial indicia 64″″ incorporates a thematically related, morphosyntactically conformational, paradigmatic component word string indicium 80′ into a single indicium. The pictorial elements are mnemonic devices that aid in the recollection of the linguistic elements, and the linguistic elements are mnemonic devices that aid in the recollection of the pictorial elements. All of the visual and linguistic cues help the operator to remember the combination. This embodiment employs the most fully integrated mnemonic device of all of the preferred embodiments of the combination lock of the present invention.

FIG. 20 is a table showing an abridged paradigm for a preferred embodiment of the combination lock in accordance with the present invention, showing a morphosyntactically conformational, paradigmatic semantic word string theme 120 and a single pictorial element 122. The theme is a statement in the form of a maxim or truism paired either logically or ironically with the portrait of a famous person who might have made that statement.

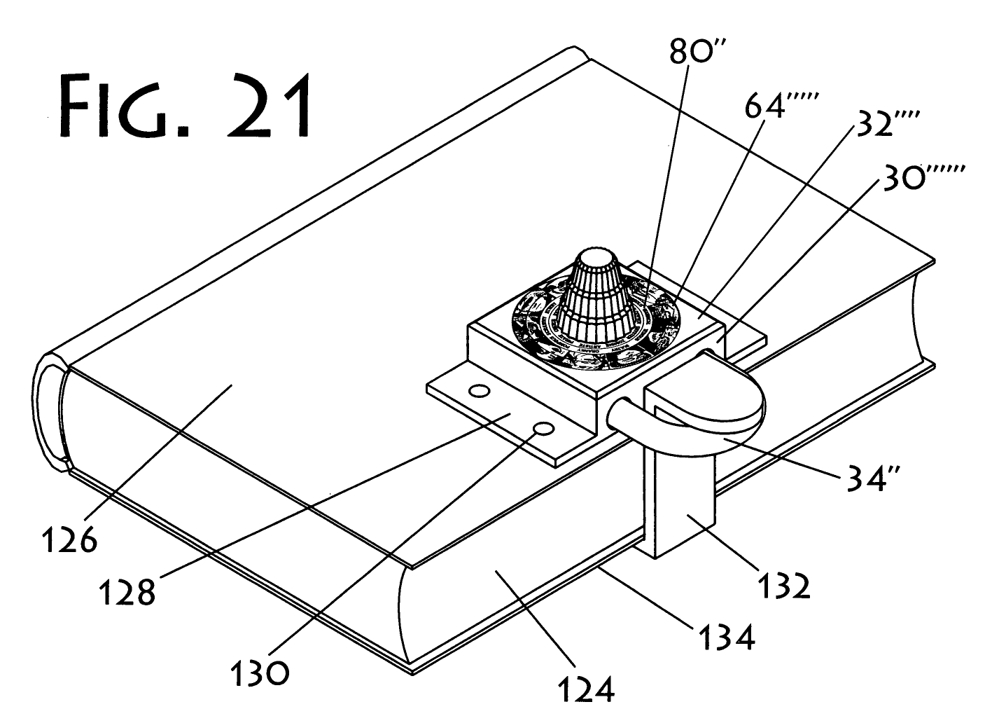

FIG. 21 shows a preferred embodiment of the combination lock in accordance with the present invention, showing a dedicated, inbuilt lock for a diary with component pictorial and paradigmatic semantic word string indicia. The figure shows a diary 124 with a front cover 126 housing an inbuilt combination lock 30′″″. The figure shows thematic, paradigmatic, component pictorial indicia 64′″″, morphosyntactically conformational, paradigmatic semantic word string indicia 80″, and a lock body 32″″ having two flanges 128 protruding from the lock body 32″″. The figure shows rivets 130 that pass through the flanges 128, attaching the lock body to the front cover 126 of the diary 124. The figure also shows a shackle 34″ that can be closed around a hook 132 that is riveted to the back cover 134 of the diary 124 and that can be released from the hook 132 when the combination lock is unlocked.

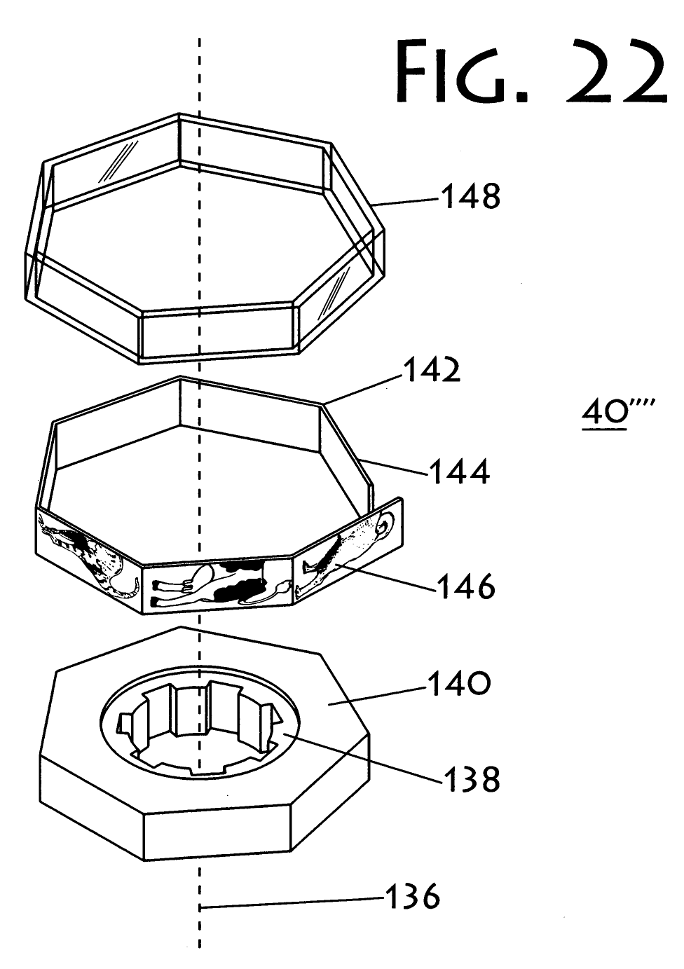

FIG. 22 shows a disc-type tumbler 40″″ in exploded view along its axis of rotation 136. The figure shows a steel hub 138, a heptagonal-prism-shaped, hard plastic tumbler body 140, a partially folded rectangular strip 142 of imprintable paper or plastic medium 144 with multiple indicia images 146 printed thereon, and a heptagonal, protective, transparent plastic sheath 148.

While the invention has been described with respect to certain specific embodiments, it will be appreciated that many modifications may be made by those skilled in the art without departing from the spirit of the invention. It is intended, therefore, by the appended claims to cover all such modifications as fall within the scope of the invention.

I claim:

1. A mnemonic combination locking system with thematic, paradigmatic indicia, comprising:
(a) a combination lock comprising a plurality of tumblers having viewable, imprintable surface area,
(b) a plurality of indicia comprising a plurality of thematic, paradigmatic indicia imprinted upon said viewable, imprintable surface area of said plurality of tumblers,
(c) a primary combination viewing area comprising a plurality of indicia viewing zones for the concurrent display of a plurality of said indicia, said primary combination viewing area comprising a graphic layout template of an overall, generic composite theme selected from the group consisting of a composite pictorial theme; a morphosyntactically conformational, paradigmatic, semantic word string theme; a theme with both morphosyntactically conformational, paradigmatic, semantic word string and pictorial elements; and a theme with both composite pictorial and semantic word elements, said overall, generic composite theme forming a conceptual whole recognizable as such by a human operator, said overall, generic composite theme comprising a plurality of constituent, generic subthemes selected from the group consisting of component pictorial subthemes; component semantic word subthemes; and subthemes with combined component pictorial and semantic word elements, said plurality of constituent, generic subthemes being recognizable by said human operator as component parts of said conceptual whole, said graphic layout template comprising a plurality of viewable surface sections being at most equal in number to said plurality of indicia viewing zones of said primary combination viewing area, each of said plurality of viewable surface sections being configured within said graphic layout template so as to depict one of said plurality of constituent, generic subthemes in relative orientation so as to be recognizable by said human operator as one of said component parts of said conceptual whole, said thematic, paradigmatic indicia comprising a plurality of subsets of subthematic, paradigmatic indicia, each of said subsets of subthematic, paradigmatic indicia comprising a plurality of specific and distinctive subthematic, paradigmatic exemplar indicia that are exemplars of one of said constituent, generic subthemes, said graphic layout template being selected from the group consisting of a pictorial template for a plurality of composite images comprising a plurality of configurations of the subthematic, paradigmatic pictorial exemplar indicia; a linguistic template for a plurality of morphosyntactically conformational, paradigmatic, semantic word string images comprising a plurality of configurations of the subthematic, paradigmatic word exemplar indicia; and a combined pictorial and linguistic template for a plurality of composite pictorial and word string images, and
(d) operational means for causing to be positioned within said plurality of indicia viewing zones of said primary combination viewing area a configuration of a plurality of said indicia, such that the graphic layout template composite images can be made sequentially viewable to said human operator by said human operator sequentially employing said operational means with diverse configurations of said indicia, and such that said combination lock may be rendered into an unlocked state by said human operator employing said operational means to cause to be positioned in relative orientation within said plurality of indicia viewing zones a predetermined configuration of a plurality of said indicia, and such that said combination lock remains in a locked state when other configurations of said indicia are positioned in relative orientation within said plurality of indicia viewing zones.

2. The mnemonic combination locking system of claim 1 wherein said combination lock is a combination padlock.

3. The mnemonic combination locking system of claim 1 wherein said combination lock is a permutation padlock.

4. The mnemonic combination locking system of claim 1 wherein said combination lock is a dedicated, inbuilt combination lock that bars access to an enclosed volume of space selected from the group consisting of the interior of a locker, the interior of a closed container, and the interior of a diary.

5. The mnemonic combination locking system of claim 1 wherein said combination lock is a dedicated, inbuilt permutation lock that bars access to an enclosed volume of space selected from the group consisting of the interior of a locker, the interior of a closed container, and the interior of a diary.

6. The mnemonic combination locking system of claim 1 wherein said specific and distinctive subthematic, paradigmatic exemplar indicia are derived by computer image processing means from source pictorial graphic images of artwork selected from the group consisting of color photographic images, black-and-white photographic images, photomontages, etchings, drawings, pastel drawings, charcoal drawings, pen-and-ink drawings, prints, computer-generated digital images, paintings, lithographs, offset lithographs, mezzotints, monotypes, woodcut prints, photoengravings, mixed-media collages, cartoon images, engravings, serigraphs, drypoint prints, collagraphs, and aquatints.

7. The mnemonic combination locking system of claim 1 wherein said overall, generic composite theme is a theme selected from the group consisting of a composite humanoid face formed from a plurality of component humanoid face sections, a composite humanoid body formed from a plurality of component humanoid body sections, a composite animal face formed from a plurality of component animal face sections, a composite animal body formed from a plurality of component animal body sections, a composite object formed from a plurality of component object sections, a still life arrangement of objects formed from a plurality of object images, and a composite landscape formed from a plurality of component landscape sections.

8. The mnemonic combination locking system of claim 1 further including a lock body with viewable, imprintable surface area imprinted with a fiducial set of said component indicia in lieu of a fiducial mark and configured within said graphic layout template so as to depict one of said plurality of constituent, generic subthemes in relative orientation so as to be recognizable by said human operator as one of said component parts of said conceptual whole.

9. The mnemonic combination locking system of claim 1 wherein said thematic, paradigmatic indicia are embossed, relief component word string indicia.

10. The mnemonic combination locking system of claim 1 wherein said thematic, paradigmatic indicia are embossed, relief component pictorial indicia.

11. The mnemonic combination locking system of claim 1 wherein said plurality of tumblers are coaxially nested disc-type tumblers and said viewable, imprintable surface area comprises the visible outer surface area of the tumblers.

12. The mnemonic combination locking system of claim 11, further including a folded rectangular strip of imprintable medium with multiple indicia images printed thereon affixed to and girding each of said disc-type tumblers.

13. The mnemonic combination locking system of claim 12, further including a protective, transparent plastic sheath girding said folded rectangular strip of imprintable medium.

14. The mnemonic combination locking system of claim 1 wherein said plurality of tumblers are nested circular dial-type tumblers and said viewable, imprintable surface area comprises the visible, substantially coplanar faces of the tumblers.

15. A method for manufacturing a mnemonic combination locking system with thematic, paradigmatic indicia, comprising the steps of:
(a) providing a combination lock comprising (1) a plurality of tumblers having viewable, imprintable surface area, (2) a plurality of indicia, (3) a primary combination viewing area comprising a plurality of indicia viewing zones for the concurrent display of a plurality of said indicia, (4) viewable surface area selected from the group consisting of imprintable medium and embossable medium, said indicia being imprinted upon said viewable surface area, and (5) operational means for causing to be positioned within said plurality of indicia viewing zones of said primary combination viewing area a configuration of a plurality of said indicia,
(b) determining an overall, generic composite theme selected from the group consisting of a composite pictorial theme; a morphosyntactically conformational, paradigmatic, semantic word string theme; a theme with both morphosyntactically conformational, paradigmatic, semantic word string and pictorial elements; and a theme with both composite pictorial and semantic word elements, said overall, generic composite theme forming a conceptual whole recognizable as such by said human operator, said overall, generic composite theme comprising a plurality of constituent, generic subthemes selected from the group consisting of component pictorial subthemes; component morphosyntactically conformational, paradigmatic semantic word subthemes; and subthemes with combined component pictorial and semantic word elements, said plurality of constituent, generic subthemes being recognizable by said human operator as component parts of said conceptual whole,
(c) providing a graphic layout template of said overall, generic composite theme, said graphic layout template comprising a plurality of viewable surface sections being at most equal in number to said plurality of indicia viewing zones of said primary combination viewing area, each of said plurality of viewable surface sections being configured within said graphic layout template so as to depict one of said plurality of constituent, generic subthemes in relative orientation so as to be recognizable by said human operator as one of said component parts of said conceptual whole,
(d) providing a plurality of thematic, paradigmatic indicia comprising a plurality of subsets of subthematic, paradigmatic indicia selected from the group consisting of subthematic, paradigmatic component pictorial indicia, subthematic, paradigmatic component word indicia, and subthematic, paradigmatic indicia with combined component pictorial and word elements, each of said subsets of subthematic, paradigmatic indicia comprising a plurality of specific and distinctive subthematic, paradigmatic exemplar indicia that are exemplars of one of said constituent, generic subthemes, said graphic layout template being selected from the group consisting of a pictorial template for a plurality of composite images comprising a plurality of configurations of the subthematic, paradigmatic pictorial exemplar indicia; a linguistic template for a plurality of morphosyntactically conformational, paradigmatic, semantic word string images comprising a plurality of configurations of the subthematic, paradigmatic word exemplar indicia; and a combined pictorial and linguistic template for a plurality of composite pictorial and word string images that can be made sequentially viewable to said human operator by said human operator sequentially employing said operational means with diverse configurations of said indicia,
(e) providing graphic layout means for rendering said indicia comprising said specific and distinctive subthematic, paradigmatic exemplars into transferable reproduction images, and
(f) providing image transfer means selected from the group consisting of printing means for transferring said transferable reproduction images in proper alignment onto said imprintable medium and embossing means for transferring said transferable reproduction images in proper alignment onto said embossable medium.

16. The method of claim 15 wherein said specific and distinctive subthematic, paradigmatic exemplar indicia are derived by computer image processing means from source pictorial graphic images of artwork selected from the group consisting of color photographic images, black-and-white photographic images, photomontages, etchings, drawings, pastel drawings, charcoal drawings, pen-and-ink drawings, prints, computer-generated digital images, paintings, lithographs, offset lithographs, mezzotints, monotypes, woodcut prints, photoengravings, mixed-media collages, cartoon images, engravings, serigraphs, drypoint prints, collagraphs, and aquatints.

17. The method of claim 15 wherein said overall, generic composite theme is a theme selected from the group consisting of a composite humanoid face formed from a plurality of component humanoid face sections, a composite humanoid body formed from a plurality of component humanoid body sections, a composite animal face formed from a plurality of component animal face sections, a composite animal body formed from a plurality of component animal body sections, a composite object formed from a plurality of component object sections, a still life arrangement of objects formed from a plurality of object images, and a composite landscape formed from a plurality of component landscape sections.
whereby a manufacturer of said mnemonic combination lock can have designed and manufactured a variety of novel, fully functional, attractive, and entertaining mnemonic combination locks,
whereby said human operator can enjoy creating, at his leisure, many amusing, bizarre, and memorable composite images with the lock and can subsequently utilize the lock for all conventional purposes, and
whereby any other human operator with malicious intent, being unknowledgeable of which of said plurality of configurations of said indicia is a correct combination, cannot readily unlock said mnemonic combination lock.
